(19) United States
(12) Patent Application Publication
(10) Pub. No.: US 2004/0028921 A1
(43) Pub. Date: Feb. 12, 2004

(54) Polyamide-coated metal surfaces

(75) Inventor: Nicolas Amouroux, Valailles (FR)

Correspondence Address: MILLEN, WHITE, ZELANO & BRANIGAN, P.C., 2200 CLARENDON BLVD., SUITE 1400, ARLINGTON, VA, 22201, US

(73) Assignee: ATOFINA, Puteaux (FR)

(21) Appl. No.: 10/408,651

(22) Filed: Apr. 8, 2003

(30) Foreign Application Priority Data
Apr. 8, 2002 (FR) 02.04312

(51) Int. Cl. B32B 15/00

(52) U.S. Cl. 428/459; 428/684; 428/659; 428/474.4

(57) ABSTRACT

A metal surface is coated with a coating comprising, in succession starting from the metal:

optionally, a primer layer;

optionally, a tie layer; and

a polyamide-based layer consisting of a blend of a polyamide and of a polyolefin functionalized by an unsaturated carboxylic acid anhydride.

Advantageously, the metal surface is the outer surface of a tube, particularly a small-diameter pipe having, for example, an outside diameter of 4 to 50 mm. The metal may be any metal, but the coating is very useful for steel and its alloys and for aluminium and its alloys. The optionally, a tie layer; aluminium may be anodized. Thus, the coated surface can comprise aluminium, the anodizing layer, the optional primer, the optional tie and the PA-based layer. The steel may be coated with zinc or a Zn-based alloy (such as, for example, a Zn—Al or Zn—Fe mixture) or with aluminium or an Al-based alloy and/or treated by chromatizing or phosphatizing. Thus, the coated surface can comprise steel, the optional zinc or aluminium layer, the optional chromatizing or phosphatizing treatment layer, the optional primer, the optional tie and the PA-based layer. Preferably, the chromatizing is carried out with Cr^{III}.

### FIELD OF THE INVENTION

Small-diameter metal tubes, for example those having diameters from 4 mm to 50 mm, are used in motor vehicles (brake line, fuel line, power steering, air conditioning, hydraulics). The metals most often used are aluminium and galvanized steel. These tubes must be coated in order to protect them from corrosion—nylon-11 and nylon-12 are customarily used. The current coating processes are powder coating on a cold tube (which is then heated in order to melt the powder and form a film) or powder coating on a hot tube, and extrusion coating with molten polyamide. The polyamides not only provide corrosion protection but also mechanical strength. The invention relates to novel coatings based on a polyamide to which a polyolefin functionalized by a carboxylic acid anhydride has been added, in particular those coatings that are made by extrusion.

The metal tubes to be coated may also be treated by chromatizing them. Hitherto, the chromatizing treatments have been made with Cr^{VI}, but these Cr^{VI}-based solutions will no longer be used after 2003 (application of European regulations restricting the use of Cr^{VI}). The coating systems proposed in the present invention exhibit good performance when chromium (III) (Cr^{III}) chromatizing is used.

### PRIOR ART AND THE TECHNICAL PROBLEM

Patent GB 1 253 633 discloses a coating for a steel surface with a powder consisting of a blend of an epoxy and of a 6,6/6,12 copolyamide without the use of a primer.

Japanese Application JP 10120972 A published in 1998 discloses a coating for a steel surface with a powder consisting of a blend of a polyamide and melamine without using a primer.

Japanese Application JP 10330651 A published in 1998 describes a coating for a steel surface with a powder consisting of a blend of a polyamide and an alicyclic hydrocarbon resin containing OH functional groups without using a primer.

Patent EP 969 053 discloses the coating of a metal surface with a powder consisting of a blend of a polyamide and a polyethylene wax without using a primer. The powder is deposited by an electrostatic process and the wax prevents the powder from being detached from the surface while it is being heated.

U.S. patent application Ser. No. 2001-0023537 A discloses a metal surface coated in succession with an organosilane primer and then with a polyamide.

Japanese Application JP 56036550 A published in 1981 discloses a coating of the same kind as the previous one, but the primer is a mixture of bisphenol, epichlorohydrin, phenol and a monocarboxylic acid, this mixture being deposited as a solution in an organic solvent.

Patent Application JP 52026585 A published in 1977 discloses a metal surface coated in succession with a primer which is a silane-filled polypropylene and then with a polyamide.

Patent DE 4 400 811 discloses a metal surface, which may be galvanized, coated in succession with a chromatizing layer and then with a polyamide.

Patent EP 768 488 describes a metal surface coated in succession either with a thermoplastic, possibly a polyamide, or with an epoxy and then either with an elastomer or with a polyamide alloy.

Patent Application JP 09262903 A published in 1997 discloses a metal surface coated in succession with a primer, which is a blend of an epoxy and a silane, and then with a polyamide.

Japanese Application JP 61296079 A published in 1986 discloses a metal surface coated, without a primer, with a polyamide-based composition. The said composition consists of:

100 parts comprising:

50 to 99.5% of polyamide,

50 to 0.5% of one or more products chosen from ionomers, EPRs and polyolefins grafted by a polar group;

0.1 to 5 parts of a silane; and

0.005 to 4 parts of an antioxidant.

U.S. Pat. No. 4,690,856 describes a metal surface coated without a primer with a composition very similar to the previous one.

Patent GB 2 262 939 discloses a metal surface coated in succession with an epoxy primer and then with a composition which is a blend of an amorphous polyamide and a polymer containing an acid group. The polymer containing the acid group is an ethylene-acrylic acid copolymer containing 12% by weight of acid.

Patent Application WO 95/30109 describes polymer-coated surfaces made of steel, which may be galvanized and may also be treated by chromatizing or phosphatizing them, or made of a zinc-aluminium alloy. This coating may be:

either a layer of a nylon-12/ionomer blend and then a nylon-12 outer layer;

or an ionomer layer and then an outer layer of a nylon-12 ionomer blend;

or a layer of a nylon-12/ionomer blend and then a nylon-6 outer layer.

The use of silanes in the polyamide layer or in the primer layer requires working under conditions such that these compositions are kept away from moisture during their storage before they are used. The use of ionomers as a tie between the optionally treated steel surface and the polyamide layer does not give sufficient adhesion to withstand salt-fog testing. The addition of an ionomer or of an ethylene-acrylic acid copolymer to the polyamide is insufficient for this layer to have good adhesion after exposure to salt fog.

It has now been found that a salt-fog resistant coating is obtained by adding a polyolefin functionalized by an unsaturated carboxylic acid anhydride to the polyamide.

### BRIEF DESCRIPTION OF THE INVENTION

The present invention relates to a coated metal surface comprising, in succession starting from the metal:

optionally, a primer layer;

optionally, a tie layer;

a polyamide-based layer comprising a blend of a polyamide and of a polyolefin functionalized by an unsaturated carboxylic acid anhydride.

The metal surface is advantageously the outer surface of tubes. These tubes may be of any diameter, but the invention is particularly useful for small-diameter pipes, for example having an outside diameter of 4 to 50 mm.

The metal may be any metal, but the invention is very useful for steel and its alloys and for aluminium and its alloys.

The aluminium may be anodized. Thus, according to one aspect, the coated surface of the invention comprises aluminium, the anodizing layer, the optional primer, the optional tie and the PA-based layer.

The steel may be coated with zinc or a Zn-based alloy (such as, for example, a Zn—Al or Zn—Fe mixture) or with aluminium or an Al-based alloy and/or treated by chromatizing or phosphatizing. Thus, according to another aspect, the coated surface of the invention comprises steel, the optional zinc or aluminium layer, the optional chromatizing or phosphatizing treatment layer, the optional primer, the optional tie and the PA-based layer. Preferably, the chromatizing is carried out with Cr^{III}.

The advantage of the functionalized polyolefin being present in the polyamide is twofold: in cases in which no primer is used, the functionalized polyolefin modules present at the interface increase adhesion; in cases in which a primer is used, the presence of a “soft” phase relaxes the internal stresses and notch propagation is reduced.

The present invention also relates to a process for manufacturing these coated surfaces. Anodizing, chromatizing or phosphatizing are treatments known per se and are carried out using standard techniques. Optionally, after anodizing or chromatizing (or phosphatizing), it is possible to use a cold plasma to clean/oxidize the surface of the Cr^{III}-chromatized galvanized steel tube before the primer or polyamide coating.

The primer is deposited in liquid form or by spraying, or electrostatic spraying if the primer is a powder, onto the metal surface. The metal surface is then heated to 200-240° C., for about 20 to 30 seconds, that is to say before the primer is crosslinked or, in the case of an epoxy, a little before the end of the gelling time and before the resin is crosslinked, so that functional groups remain. According to a variant, it is also possible to deposit the primer on the already hot tube. The optional tie layer may then be deposited, either by spraying if it is powder form, or by coating or laminating. The polyamide is then deposited in the same way.

As regards the outer surface of metal tubes, the procedure is the same as for the primer or else it is extruded in an annular die (also called a crosshead) and then the optional tie is deposited by spraying, if it is available in powder form, or extruded in an annular die placed concentrically around the tube. The tie may also be extruded in a flat die producing a continuous tape which is wound around the tube, for example by rotating the tube about itself. The polyamide is then deposited in the same way. The tie and the PA may also be deposited simultaneously by coextrusion.

According to a preferred form the invention concerns a process to coat small-diameter tubes, for example having an outside diameter of 4 to 50 mm. In said process the melted polyamide (containing the functionalized polyolefin) is deposited by any means capable to cover all the outer surface of the tube. This means may be a crosshead extrusion which is used to cover metal cables (such as electrical cables) by a melted material. The optional tie layer is deposited on the same way as the polyamide. The tie layer and the polyamide may be simultaneously deposited by coextrusion, that is to say the same means supplied with the melted tie layer and the melted polyamide deposit them on the outer layer of the tube in this order: from the tube and towards outside the tube, at first the tie layer and then the poloyamide.

It is recommended to lower the temperature of the tube on which the polyamide is extruded as far as possible. However, it is necessary for the temperature of the tube to be such that the polyamide does not crystallize too quickly, otherwise the adhesion will be poor. The tube must at least be at the melting point of the PA. As an example, in the case of PA-12 the temperature of the tube (temperature of the layer on which the PA-12 is extruded) must be between 175 and 200° C. in order to obtain the best adhesion.

If the temperature of the tube is too hot, the chromatizing treatment is destroyed; if the temperature of the tube is too cold, the PA crystallizes too quickly. If a tie is used, the heating may be less. The recommended tube temperature is Tₘ of the tie+30° C. or Tₘ(PA)+30° C. if there is no tie. It is also necessary to ensure that the primer crosslinks.

### DETAILED DESCRIPTION OF THE INVENTION

With regard to the primer, this thus denotes any product which promotes adhesion to the metal surface. It is, for example, an epoxy or an epoxy acrylate. The term “epoxy primer” advantageously denotes the product of the reaction between a thermosetting epoxy resin and a hardener.

Their principle is described, for example, in KIRK-OTHMER, Encyclopedia of Chemical Technology, Vol. 9, pages 267-289, 3^{rd} edition. This layer may also be defined as any product of the reaction between an oligomer carrying oxirane functional groups and a hardener. The reactions involved during the reaction of these epoxy resins result in a crosslinked material corresponding to a three-dimensional network whose density depends on the base characteristics of the resins and hardeners employed.

The term “epoxy resin” is understood to mean any organic compound possessing at least two oxirane-type functional groups, which is ring-opening polymerizable. The term “epoxy resins” denotes any of the usual epoxy resins liquid at room temperature (23° C.) or at a higher temperature. These epoxy resins may be, on the one hand, monomeric or polymeric and, on the other hand, aliphatic, cycloaliphatic, heterocyclic or aromatic. As examples of such epoxy resins, mention may be made of the diglycidyl ether of resorcinol, the diglycidyl ether of bisphenol A, the triglycidyl ether of p-aminophenol, the diglycidyl ether of bromobisphenol F, the triglycidyl ether of m-aminophenol, tetraglycidyl methylene dianiline, the triglycidyl ether of (trihydroxyphenyl)-methane, polyglycidyl ethers of phenol-formaldehyde novolac, polyglycidyl ethers of orhocresol novolac and tetraglycidul ethers of tetraphenylethane. Mixtures of at least two of these resins may also be used.

Epoxy resins possessing at least 1.5 oxirane functional groups per molecule, and more particularly epoxy resins containing between 2 and 4 oxirane functional groups per molecule, are preferred. Epoxy resins possessing at least one aromatic ring, such as diglycidyl ethers of bisphenol A, are also preferred.

With regard to the hardeners, it is general practice to use the hardeners for epoxy resins as hardeners, which react at room temperature or at temperatures above room temperature. As non-limiting examples, mention may be made of:

acid anhydrides, including succinic anhydride;

aromatic or aliphatic polyamines, including diaminodiphenylsulphone (DDS) or methylene dianiline or 4,4′-methylene-bis-(3-chloro-2,6-diethylaniline) (MCDEA);

dicyandiamide and its derivatives;

imidazoles;

polycarboxylic acids;

polyphenols.

The resins used in the present invention can be crosslinked between 180 and 250° C.

The gel time is defined by the AFNOR NFA 49-706 standard. This is the time needed to cause a rapid increase in the viscosity at a defined temperature. The gel time is advantageously between 20 and 60 seconds.

Advantageously, the T_{g} is above 120° C. These resins may be in the form of a powder or liquid which is sprayed onto the preheated metal surface.

Advantageously, these are one-component resin powders, which are conventionally obtained as follows:

the epoxy resin (which is solid at room temperature, e.g. DGEBA, of high mass) is melt-blended with the hardener, the optional accelerators, the fillers, etc. During this step there is precrosslinking, but without going as far as the gel point;

after blending, the compound is cooled so as to stop the crosslinking;

the homogeneous solid obtained is ground to a powder.

This results in a one-component powder which can be applied by standard methods and which completes its crosslinking on contact with the hot metal. For these applications, systems which crosslink only at high temperature (180-240° C.) are generally preferred so that at room temperature there is no storage problem (pot life: 6 months-1 year).

These resins may include additives such as silicones, pigments such as titanium dioxide, iron oxides and carbon black, and fillers such as calcium carbonate, talc and mica.

The primer is, for example, that sold by Atofina under the brand name PRIMGREEN®.

With regard to the tie, this thus denotes any product allowing adhesion to the polyamide layer. Advantageously the tie is a functionalized polyolefin carrying a carboxylic acid or carboxylic acid anhydride functional group. It may be blended with an unfunctionalized polyolefin. To simplify matters, functionalized polyolefins (B1) and unfunctionalized polyolefins (B2) are described below.

An unfunctionalized polyolefin (B2) is conventionally a homopolymer or an alpha-olefin or diolefin copolymer, such as, for example, ethylene, propylene, 1-butene, 1-octene and butadiene. By way of example, mention may be made of:

polyethylene homopolymers and copolymers, particularly LDPE, HDPE, LLDPE (linear low-density polyethylene), VLDPE (very low-density polyethylene) and metallocene polyethylene;

propylene homopolymers or copolymers;

ethylene/alpha-olefin copolymers, such as ethylene/propylene, EPR (the abbreviation for ethylene/propylene rubber) and ethylene/propylene diene (EPDM);

styrene/ethylene-butene/styrene (SEBS), styrene/butadiene/styrene (SBS), styrene/isoprene/styrene (SIS) and styrene/ethylene-propylene/styrene (SEPS) block copolymers;

copolymers of ethylene with at least one product chosen from salts or esters of unsaturated carboxylic acids, such as alkyl (meth)acrylate (for example methyl acrylate), or vinyl esters of saturated carboxylic acids, such as vinyl acetate, the proportion of comonomer possibly being up to 40% by weight.

The functionalized polyolefin (B1) may be an alpha-olefin polymer having reactive groups (functional groups); such reactive groups are acid functional groups or anhydride functional groups. As an example, mention may be made of the above polyolefins (B2) grafted or copolymerized or terpolymerized by carboxylic acids or the corresponding salts or esters, such as (meth)acrylic acid, or else by carboxylic acid anhydrides, such as maleic anhydride. A functionalized polyolefin is, for example, a PE/EPR blend, the weight ratio of which may vary widely, for example between 40/60 and 90/10, the said blend being cografted with an anhydride, especially maleic anhydride, with a grafting ratio of, for example, 0.01 to 5% by weight.

The functionalized polyolefin (B1) may be chosen from the following (co)polymers grafted with maleic anhydride, in which the degree of grafting is, for example, from 0.01 to 5% by weight:

PE, PP, copolymers of ethylene with propylene, butene, hexene or octene, containing for example from 35 to 80% ethylene by weight;

ethylene/alpha-olefin copolymers, such as ethylene/propylene, EPR (the abbreviation for ethylene/propylene rubber) and ethylene/propylene diene (EPDM);

styrene/ethylene-butene/styrene (SEBS), styrene/butadiene/styrene (SBS), styrene/isoprene/styrene (SIS) and styrene/ethylene-propylene/styrene (SEPS) block copolymers;

ethylene-vinyl acetate copolymers (EVA) containing up to 40% vinyl acetate by weight;

ethylene-alkyl (meth)acrylate copolymers containing up to 40% alkyl (meth)acrylate by weight; and

ethylene-vinyl acetate (EVA)/alkyl (meth)acrylate copolymers containing up to 40% by weight of comonomers.

The functionalized polyolefin (B1) may also be a copolymer or terpolymer of at least the following monomers: (1) ethylene; (2) an alkyl (meth)acrylate or a vinyl ester of a saturated carboxylic acid and (3) an anhydride, such as maleic anhydride, or (meth)acrylic acid.

As examples of functionalized polyolefins of the latter type, mention may be made of the following copolymers, in which ethylene preferably represents at least 60% by weight and in which the termonomer (the functional group) represents, for example, from 0.1 to 10% by weight of the copolymer:

ethylene/alkyl (meth)acrylate/(meth)acrylic acid or maleic anhydride copolymers;

ethylene/vinyl acetate/maleic anhydride copolymers; and

ethylene/vinyl acetate or alkyl (meth)acrylate/(meth)acrylic acid or maleic anhydride copolymers.

The term “alkyl (meth)acrylate” in (B1) or (B2) denotes C₁ to C₁₂ alkyl acrylates and methacrylates, these possibly being chosen from methyl acrylate, ethyl acrylate, n-butyl acrylate, isobutyl acrylate, 2-ethyl hexyl acrylate, cyclohexyl acrylate, methyl methacrylate and ethyl methacrylate.

The copolymers mentioned above, (B1) and (B2), may be random copolymers or block copolymers and have a linear or branched structure.

The molecular weight, the MFI and the density of these polyolefins may also vary widely, as a person skilled in the art will appreciate. MFI is the abbreviation for Melt Flow Index, which is measured according to the ASTM 1238 standard.

Advantageously, the unfunctionalized polyolefins (B2) are chosen from polypropylene homopolymers or copolymers and any ethylene homopolymer or copolymer of ethylene with a comonomer of the higher alpha-olefin type, such as butene, hexene, octene or 4-methyl-1-pentene. Mention may be made, for example, of PP, high-density PE, medium-density PE, linear low-density PE, low-density PE and very low-density PE. These polyethylenes are known to a person skilled in the art as being produced according to a “radical” process, using catalysis of the “Ziegler” type or, more recently, using catalysis referred to as “metallocene” catalysis.

Advantageously, the functionalized polyolefins (B1) are chosen from any polymer comprising alpha-olefin units and units carrying polar reactive functional groups, such as carboxylic acid or carboxylic acid anhydride functional groups. As examples of such polymers, mention may be made of ethylene-alkyl acrylate-maleic anhydride terpolymers, such as LOTADER®, or polyolefins grafted by maleic anhydride, such as OREVAC® polymers, and ethylene-alkyl acrylate-(meth)acrylate acid terpolymers.

As first example of a tie, mention may be made of a blend of polyethylene (C1) and a polymer (C2) chosen from elastomers, very low-density polyethylenes and ethylene copolymers, the blend (C1)+(C2) being cografted by an unsaturated carboxylic acid. The polyethylene (C1) may be chosen from the abovementioned polyolefins. Advantageously, (C1) is a high-density polyethylene (HDPE) having a density of between 0.940 and 0.965. The MFI of (C1) is between 0.1 and 3 g/10 min (190° C./2.16 kg).

The copolymer (C2) may, for example, be an ethylene/propylene elastomer (EPR) or an ethylene/propylene/diene (EPDM). (C2) may also be a very low-density polyethylene (VLDPE) which is either an ethylene homopolymer or an ethylene/alpha-olefin copolymer. (C2) may also be a copolymer of ethylene with at least one product chosen from (i) unsaturated carboxylic acids, their salts, their esters; (ii) vinyl esters of saturated carboxylic acids; (iii) unsaturated dicarboxylic acids, their salts, their esters, their half-esters and their anhydrides. Advantageously, (C2) is an EPR.

Advantageously, 60 to 95 parts of (C1) per 40 to 5 parts of (C2) are used.

The blend of (C1) and (C2) is grafted with an unsaturated carboxylic acid, that is to say (C1) and (C2) are cografted. It would not be outside the scope of the invention to use a functional derivative of this acid. Examples of unsaturated carboxylic acids are those having from 2 to 20 carbon atoms, such as acrylic, methacrylic, maleic, fumaric and itaconic acids. The functional derivatives of these acids include, for example, the anhydrides, the ester derivatives, the amide derivatives and the imide derivatives.

Unsaturated dicarboxylic acids having 4 to 10 carbon atoms and their functional derivatives, particularly their anhydrides, are particularly preferred grafting monomers. These grafting monomers comprise, for example, maleic, fumaric, itaconic, citraconic, allylsuccinic, cyclohex-4-ene-1,2-dicarboxylic, 4-methylcyclohex-4-ene-1,2-dicarboxylic, bicyclo[2.2.1]hept-5-ene-1,3-dicarboxylic and x-methylbicyclo[2.2.1]hept-5-ene-2,3-dicarboxylic acids and maleic, itaconic, citraconic, allylsuccinic, cyclohex-4-ene-1,2-dicarboxylic, 4-methylene-cyclohex-4-ene-1,2-dicarboxylic, bicyclo[2.2.1]hept-5-ene-2,3-dicarboxylic and x-methylbicyclo[2.2.1]hept-5-ene-2,2-dicarboxylic anhydrides. Advantageously maleic anhydride is used.

Various known processes can be used to graft a grafting monomer onto the blend of (C1) and (C2). For example, this may be achieved by heating the polymers (C1) and (C2) to a high temperature, about 150° C. to about 300° C., in the presence or absence of a solvent and with or without a radical initiator.

In the graft-modified blend of (C1) and (C2) obtained in the abovementioned manner, the amount of grafting monomer may be chosen appropriately, but it is preferably from 0.01 to 10% and better still from 600 ppm to 2%, with respect to the weight of grafted (C1) and (C2). The amount of grafted monomer is determined by assaying the succinic functional groups by FTIR spectroscopy. The MFI (190° C./2.16 kg) of the cografted (C1) and (C2) is 5 to 30 and preferably 13 to 20 g/10 min.

Advantageously, the cografted (C1) and (C2) blend is such that the MFI₁₀/MFI₂ ratio is greater than 18.5, MFI₁₀ denoting the melt flow index at 190° C. with a load of 10 kg and MFI₂ denoting the melt flow index with a load of 2.16 kg. Advantageously, the MFI₂₀ of the blend of the cografted polymers (C1) and (C2) is less than 24. MFI₂₀ denotes the melt flow index at 190° C. with a load of 21.6 kg.

In all the following examples of ties, grafting by an unsaturated carboxylic acid means, as in the first example, that this is also a derivative of this acid, such as an anhydride for example, and that an unsaturated carboxylic acid anhydride is grafted.

As second example of a tie, mention may be made of the blends comprising:

5 to 30 parts of a polymer (D) which itself comprises a blend of a polyethylene (D1) having a density of between 0.910 and 0.940 and a polymer (D2) chosen from elastomers, very low-density polyethylenes and metallocene polyethylenes, the blend (D1)+(D2) being cografted by an unsaturated carboxylic acid;

95 to 70 parts of a polyethylene (E) having a density of between 0.910 and 0.930;

the blend of (D) and (E) being such that:

its density is between 0.910 and 0.930 and

the content of grafted unsaturated carboxylic acid is between 30 and 10 000 ppm;

the MFI (ASTM D 1238: 190° C./2.16 kg) is between 0.1 and 3 g/10 min. MFI denotes the melt flow index.

The density of the tie is advantageously between 0.915 and 0.920. Advantageously, (D1) and (E) are LLDPEs; preferably, they have the same comonomer. This comonomer may be chosen from 1-hexene, 1-octene and 1-butene.

As a third example of a tie, mention may be made of the following blends:

5 to 30 parts of a polymer (F) which itself comprises a blend of a polyethylene (F1) having a density of between 0.935 and 0.980 and a polymer (F2) chosen from elastomers, very low-density polyethylenes and ethylene copolymers, the blend (F1)+(F2) being cografted by an unsaturated carboxylic acid;

95 to 70 parts of a polyethylene (G) having a density of between 0.930 and 0.950;

the blend of (F) and (G) being such that:

its density is between 0.930 and 0.950 and advantageously between 0.930 and 0.940,

the content of grafted unsaturated carboxylic acid is between 30 and 10 000 ppm and

the MFI (melt flow index) measured according to ASTM D 1238 is between 5 and 100 g/10 min (190° C./21.6 kg).

As a fourth example of a tie, mention may be made of polyethylene grafted by maleic anhydride, having an MFI of 0.1 to 3, a density of between 0.920 and 0.930 and containing 2 to 40% by weight of materials insoluble in n-decane at 90° C. To determine the n-decane insolubles, the grafted polyethylene is dissolved in n-decane at 140° C., the solution is cooled to 90° C. and products precipitate; it is then filtered and the insolubles content is the percentage by weight which precipitates and is collected by filtration at 90° C. If the content is between 2 and 40%, the tie exhibits good resistance to petrol.

Advantageously, the grafted polyethylene is diluted in an ungrafted polyethylene, such that the tie is a blend of 2 to 30 parts of a grafted polyethylene having a density of between 0.930 and 0.980 and 70 to 98 parts of an ungrafted polyethylene having a density of between 0.910 and 0.940, preferably between 0.915 and 0.935.

As a fifth example of a tie, mention may be made of the blends comprising:

50 to 100 parts of a polyethylene homopolymer or copolymer (J) having a density of greater than or equal to 0.9;

0 to 50 parts of a polymer (K) chosen from a polypropylene homopolymer or copolymer (K1), a poly(1-butene) homopolymer or copolymer (K2) and a polystyrene homopolymer or copolymer (K3);

the amount of (J)+(K) being 100 parts;

the blend of (J)+(K) being grafted by at least 0.5% by weight of a functional monomer;

this grafted blend itself being diluted in at least one polyethylene homopolymer or copolymer (L) or in at least one polymer (M) having an elastomeric character or in a blend of (L) and (M).

According to one embodiment of the invention (J) is an LLDPE having a density of 0.91 to 0.930, the comonomer having from 4 to 8 carbon atoms. According to another embodiment of the invention, (K) is an HDPE, advantageously having a density of at least 0.945 and preferably 0.950 to 0.980.

Advantageously, the functional monomer is maleic anhydride and its content is from 1 to 5% by weight of (J)+(K).

Advantageously, (L) is an LLDPE, the comonomer of which has from 4 to 8 carbon atoms, and preferably its density is at least 0.9 and preferably 0.910 to 0.930.

Advantageously, the amount of (L) or (M) or (L)+(M) is from 97 to 75 parts per 3 to 25 parts of (J)+(K), the amount of (J)+(K)+(L)+(M) being 100 parts.

As a sixth example of a tie, mention may be made of blends consisting of an HDPE-, LLDPE-, VLDPE- or LDPE-type polyethylene, 5 to 35% of a grafted metallocene polyethylene and 0 to 35% of an elastomer, the total being 100%.

As a seventh example of a tie, mention may be made of the blends comprising:

at least one polyethylene or one ethylene copolymer;

at least one polymer chosen from polypropylene or a propylene copolymer, a poly(1-butene) homopolymer or copolymer, a polystyrene homopolymer or copolymer, and preferably polypropylene; this blend being grafted by a functional monomer and itself being optionally diluted in at least one polyolefin or at least one polymer having an elastomeric character or in a blend thereof. In the above grafted blend, polyethylene advantageously represents at least 50% and preferably 60 to 90% by weight of this blend.

Advantageously, the functional monomer is chosen from carboxylic acids and their derivatives, acid chlorides, isocyanates, oxazolines, epoxides, amines or hydroxides, and preferably unsaturated dicarboxylic acid anhydrides.

As an eighth example of a tie, mention may be made of the blends comprising:

at least one LLDPE or VLDPE polyethylene;

at least one ethylene-based elastomer chosen from ethylene-propylene copolymers and ethylene-butene copolymers;

this polyethylene-elastomer blend being grafted by an unsaturated carboxylic acid or a functional derivative of this acid;

this cografted blend optionally being diluted in a polymer chosen from polyethylene homopolymers or copolymers and styrene block copolymers; the tie having:

(a) an ethylene content which is not less than 70 mol %;

(b) a carboxylic acid or carboxylic acid derivative content of 0.01 to 10% by weight of the tie and

(c) an MFI₁₀/MFI₂ ratio of 5 to 20, where MFI₂ is the melt flow index at 190° C. under a load of 2.16 kg, measured according to ASTM D1238 and MFI₁₀ is the melt flow index at 190° C. under a load of 10 kg according to ASTM D1238.

As ninth example of a tie, mention may be made of the blends comprising:

5 to 35 parts of a polymer (S) which itself consists of a blend of 80 to 20 parts of a metallocene polyethylene (S1) having a density of between 0.865 and 0.915 and 20 to 80 parts of a non-metallocene LLDPE polyethylene (S2), the blend (S1)+(S2) being cografted by an unsaturated carboxylic acid;

95 to 65 parts of a polyethylene (T) chosen from polyethylene homopolymers or copolymers, and elastomers;

the blend of (S) and (T) being such that:

the content of grafted unsaturated carboxylic acid is between 30 and 100 000 ppm,

the MFI (ASTM D1238: 190° C./2.16 kg) is between 0.1 and 10 g/10 min. MFI denotes the melt flow index and is expressed in grams per 10 minutes.

With regard to the polyamide-based layer, and first of all the polyamide, this is chosen from PA-11, PA-12, aliphatic polyamides resulting from the condensation of an aliphatic diamine having from 6 to 12 carbon atoms and of an aliphatic diacide having from 9 to 12 carbon atoms, and nylon-11/nylon-12 copolyamides having either more than 90% of nylon-11 units or more than 90% of nylon-12 units.

As examples of aliphatic polyamides resulting from the condensation of an aliphatic diamine having from 6 to 12 carbon atoms and of an aliphatic diacide having from 9 to 12 carbon atoms, mention may be made of:

PA-6,12 resulting from the condensation of hexamethylenediamine and 1,12-dodecanedioic acid;

PA-9,12 resulting from the condensation of the C₉ diamine and 1,12-dodecanedioic acid;

PA-10,10 resulting from the condensation of the C₁₀ diamine and 1,10-decanedioic acid; and

PA-10,12 resulting from the condensation of the C₁₀ diamine and 1,12-dodecanedioic acid.

As regards the nylon-11/nylon-12 copolyamides having either more than 90% of nylon-11 units or more than 90% of nylon-12 units, these result from the condensation of 1-amino undecanoic acid with lauryllactam (or the C₁₂ alpha, omega-amino acid).

The PA may be conducting.

With regard to the polyolefin functionalized by an unsaturated carboxylic acid anhydride, this may be chosen from ties as defined above, except that the functional group is limited to unsaturated carboxylic acid anhydrides.

Advantageously, the proportion of functionalized polyolefin is from 1 to 20% by weight per 99 to 80% of polyamide respectively, and preferably from 5 to 15% per 95 to 85% of polyamide respectively.

The functionalized polyolefin/polyamide blend may also include fillers, carbon black, antioxidants and stabilizers. These blends may be prepared by melt-blending the various constituents (apart from the optional solid additives) using the standard techniques for thermoplastics.

With regard to the thickness of the various layers, that of the polyamide may be between 120 and 180 μm, that of the tie between 20 and 50 μm and that of the primer between 10 and 15 μm.

In the foregoing and in the following examples, all temperatures are set forth uncorrected in degrees Celsius; and, unless otherwise indicated, all parts and percentages are by weight.

The entire disclosure of all applications, patents and publications, cited above and below, and of corresponding French Application No. 02.04312, filed Apr. 8, 2002, is hereby incorporated by reference.

### EXAMPLES

In the following examples, the term “Melt Index” is equivalent to the melt flow index.

### Example 1

The following polyamide blends (% by weight) were produced on a Werner® 40-type twin-screw extruder at 230° C. and granulated.

TABLE 1.1

| | PA-12-0 | |
|---|---|---|
| | control | PA-12-1 |
| PA-12 | 98.1% | 92.1% |
| MA (maleic | 0% | 6% |
| anhydride)-g-PE | | |
| Black MB | 0.9% | 0.9% |
| (masterbatch) | | |
| Stabilizer | 1% | 1% |
| Melt Index | 24.9 | 18.5 |
| (235° C./1 kg in | | |
| g/10 min | | |

The PA-12 used was a fluid grade produced by Atofina (AECN). The MA-g-PE was a blend of polyolefins grafted with maleic anhydride, produced by Atofina, of the eighth tie example type mentioned in the description (OREVAC 18302).

Extrusion over an anodized aluminium tube: a tube made of 3003 aluminium having the dimensions of 9×12 was treated by phosphoric anodic oxidation, heated to a temperature of between 200 and 220° C., then coated with polyamide by crosshead extrusion and finally cooled by water. The temperature of the polyamide in the extrusion head was 230° C. The coating was carried out 7 metres per minute. The thickness of the polyamide coating was 150±30 μm.

Evaluation of the Coatings

The initial adhesion of the coating to the anodized aluminium was evaluated according to the NFT 58-112 standard. The test consisted in manually peeling off the coating, which was predetached using a knife. If the coating debonds spontaneously, the rating is 0, when the peeling is difficult or even impossible, the rating is 4. The adhesion of the coating to the tube was also evaluated after exposure to brake fluid (DOT4) at 100° C. for 168 h.

The coated tubes in cross section were exposed to a neutral salt fog (5% NaCl at 35° C.). The adhesion of the coating was measured according to the NFT 58-112 standard after 1000 h and after 2000 h of exposure.

The following table gives the performance of the tubes coated with PA-12-0 and PA-12-1, respectively. The tube coated with PA-12-1 has much better properties than the tube coated with standard PA-12-0.

TABLE 1.2

| | | |
|---|---|---|
| | PA-12-0 | |
| Tube coated with: | (control) | PA-12-1 |

Initial adhesion

| | | |
|---|---|---|
| NFT 58-112 rating | 2 | 3-3.5 |

Adhesion after DOT4 (100° C./168 h)

| | | |
|---|---|---|
| NFT 58-112 rating | 0.5-1 | 1.5-2 |

Adhesion after salt fog

| | | |
|---|---|---|
| NFT 58-112 rating after | 1.5 | 2.5 |
| 1000 h | | |
| NFT 58-112 rating after | 1 | 2-2.5 |
| 2000 h | | |

Delamination after 1000 h of salt fog

| | | |
|---|---|---|
| Startin from the notch | 4.5 mm | 2.5 mm |

### Example 2

The blends described in Example 1 were extruded on a cast line (COLLIN®) so as to obtain films approximately 200 μm in thickness. In this example, the substrates used were electrogalvanized steel test plates having the dimensions of 190×90×0.75 mm, distributed by the company Etalon (Ozoir La Ferriére). After degreasing with trichloroethylene, the plates were coated with the water-dilutable primer PRIMGREEN® LAT12035 (epoxy-type primer sold by Atofina) applied with a spray gun. The thickness of the dry primer was around 10-15 μm. The polyamide films were joined to the plates by pressing. The pressing conditions were the following (COLLIN® press):

Phase 1: 275° C., low pressure for 8 minutes;

Phase 2: 275° C. at a pressure of 20 bar for 8 minutes;

Phase 3: cooling (approximately 20° C./minute).

The final thickness of the polyamide coating was approximately 150 μm. The coatings were evaluated in the same way as in Example 1. Coated plates, with the coating notched in the form of a cross right down to the metal, were also placed in the salt-fog chamber so as to measure the delamination (length over which the coating debonds starting from the notch). The performance after exposure to the salt fog is given in Table 2.1. In the case of delamination, the minimum and maximum lengths observed are reported. Note that the delamination is significantly less in the case of PA-12-1.

TABLE 2.1

| | | |
|---|---|---|
| Electrogalvanized plates | PA-12-0 | |
| coated with primer: | (control) | PA-12-1 |

Initial adhesion

| | | |
|---|---|---|
| NFT 58-112 rating | 4 | 4 |

Adhesion of the salt fog

| | | |
|---|---|---|
| NFT 58-112 after 300 h | 3.5 | 3.5 |
| NFT 58-112 after 500 h | 3.5 | 3.5 |
| NFT 58-112 after 1000 h | 3.5 | 3.5 |

Delamination after salt fog

| | | |
|---|---|---|
| Min-max (mm) after 300 h | 1-9 | 1-3 |
| (4 tests) | 7-30 | 0-0 |
| | 0-1 | 0-0 |
| | 1-6 | 1-5 |
| Min-max (mm) after 500 h | 3-10 | 1-4 |
| (2 tests) | 1-3 | 0-0 |
| Min-max (mm) after 1000 h | 3-10 | 4-10 |
| (2 tests) | 30-30 | 0-0 |

### Example 3

The following blends were prepared in an extruder, as described in Example 1. These blends were extruded as sheet and then pressed onto electrogalvanized plates degreased as in Example 2, but without a primer or any surface treatment. The formulations and the adhesion measured according to the NFT 58-112 standard are given in Table 3.1. It may be seen that the blends containing PA-11 have substantially improved adhesion.

TABLE 3.1

| | PA-12-2 | PA-12-3 | PA-12-4 | PA-12-5 |
|---|---|---|---|---|
| PA-12 | 93% | 81% | 63% | 63% |
| PA-11 | | 12% | 24% | 24% |
| MA-g-PE 1 | 6% | 6% | 12% | |
| MA-g-PE 2 | | | | 12% |
| Stabilizer | 1% | 1% | 1% | 1% |
| Adhesion | 0.5-1 | 2-2.5 | 2.5-3 | 3.5 |
| (NFT 58-112 | | | | |
| rating) | | | | |

The PA-12 used was the same as in Example 1;
The PA-11 used was a BMFO fluid grade;
The MA-g-PE1 was OREVAC 18302 (see Example 1);
The MA-g-PE2 was a polyolefin blend grafted with maleic anhydride-this was the tie of the ninth toe example mentioned in the description.

### Example 4

This example relates to bilayer coatings on phosphortized electrogalvanized steel (ti-cation phosphatizing, without chromic rinsing, of Etalon test plates). The first layer was a tie and the second layer the PA-12-0 described in Example 1. The ties were firstly extruded in the form of film 50 82 m in thickness. The bilayers were produced in a press, as described in Example 2. No primer was applied. The final coating had a total thickness of 150 μm, the tie having a thickness of between 20 and 50 μm. These coatings were evaluated in salt fog. The results are given in Table 4.1.

It may be seen that only the coating with MA-g-PE as tie retains good adhesion after 250 h of salt fog. The other ties are given as comparison.

TABLE 4.1

| | | | | | |
|---|---|---|---|---|---|
| | | AA | GMA | MA | |
| Tie + PA-12-0 | Ionomer | terpol. | copol. | terpol. | MA-g-PE |

Initial adhesion

| | | | | | |
|---|---|---|---|---|---|
| NFT 58-112 | 0.5 | 3.5 | 3.5-4 | 1.5-2 | 3.5 |

Adhesion after 250 h of salt fog

| | | | | | |
|---|---|---|---|---|---|
| NFT 58-112 | 0 | 2 | 0 | 1 | 3.5 |

Ionomer: SURLYN ® 1901 from DuPont;
AA terpol.: LUCALEN ® 3110 ethylene alkyl acrylate/acrylic acid terpolymer from BASF
GMA copol.: LOTADER ® AX 8840 ethylene/glycidyl methacrylate copolymer from Atofina
MA terpol.: LOTADER ® 3410 ethylene/alkyl acrylate/maleic anhydride terpolymer from Atofina;
MA-g-PE: OREVAC 18302.

### Example 5

A galvanized steel tube treated by Cr^{III} chromatizing was coated by crosshead extrusion. The line speed was 5 m/min. The temperature of the PA-12 in the head was 220° C. The PRIMGREEN LAT 12035 primer was deposited on the cold tube, the excess water was removed by a stream of hot air and then the tube was induction-heated to 330° C. in order to crosslink the primer just before the polyamide was applied. When no primer was used, the temperature of the tube was lower (200-210° C.).

To evaluate the adhesion, the NFT 58-112 test was used on straight lengths. A very low adhesion is rated 0, while excellent adhesion is rated 4. The tubes were placed in a salt-fog chamber. For each test, three tubes were notched down to the metal over a length of 20 cm and exposed for 500 h with the notch facing upwards. The average delamination from the notch was evaluated. The adhesion was evaluated two hours after removal from the chamber on three unnotched tube specimens.

The table summarizes the results obtained with and without primer (average over three tubes). The performance is excellent for the system with an aqueous primer, in particular the delamination is zero. The system without a primer has a moderate adhesion, which drops slightly after exposure to salt fog, and the delamination remains low. The temperature of the tube before application is high. Thus, the PA-12-1 coating applied to the tube at 240° C. is poor in delamination (18 mm=complete delamination).

| | | | Tube | | | Adhesion after | |
|---|---|---|---|---|---|---|---|
| | | | temperature | | Initial adhesion | 500 h | Delamination |
| | Primer | PA-12 | (° C.) | Thickness | (NFT 58-112) | (NFT 58-112) | (mm) |
| Cr″′/Zn | PRIMGREEN | PA-12-1 | 330 | 100 μm | 3.5 | 3 | 0.0 |
| Cr″′/Zn | Without | PA-12-1 | 200 | 60 μm | 2 | 1.875 | 1.2 |
| Cr″′/Zn | Without | PA-12-1 | 240 | 100 μm | 2.25 | 0.75 | 18.0 |

The preceding examples can be repeated with similar success by substituting the generically or specifically described reactants and/or operating conditions of this invention for those used in the preceding examples.

From the foregoing description, one skilled in the art can easily ascertain the essential characteristics of this invention and, without departing from the spirit and scope thereof, can make various changes and modifications of the invention to adapt it to various usages and conditions.

1. A coated metal surface comprising, in succession starting from the metal:
optionally, a primer layer;
optionally, a tie layer;
a polyamide-based layer comprising a blend of a polyamide and of a polyolefin functionalized by an unsaturated carboxylic acid anhydride.

2. A coated metal surface according to claim 1, in which the metal is aluminium.

3. A coated metal surface according to claim 2, in which the aluminium is anodized.

4. A coated metal surface according to claim 1, in which the metal is steel.

5. A coated metal surface according to claim 4, in which the steel is coated with zinc or a zinc-based alloy.

6. A coated metal surface according to claim 4, in which the steel is coated with aluminium or an aluminium-based alloy.

7. A coated metal surface according to claim 4, in which the steel is treated by chromatizing or phosphatizing it.

8. A coated metal surface according to claim 5, in which the steel coated with zinc or with a zinc-based alloy is treated by chromatization or phosphatization.

9. A coated metal surface according to claim 6, in which the steel coated with aluminium or an aluminium-based alloy is treated by chromatization or phosphatization.

10. A coated metal surface according to any one of the preceding claims, in which the tie is a functionalized polyolefin carrying a carboxylic acid or carboxylic acid anhydride functional group, the functionalized polyolefin optionally being blended with an unfunctionalized polyolefin.

11. A coated metal surface according to any one of the preceding claims, in which the proportion of functionalized polyolefin is from 1 to 20% by weight per 99 to 80% of polyamide, respectively.

12. A coated metal surface according to claim 11, in which the proportion of functionalized polyolefin is from 5 to 15% per 95 to 85% of polyamide, respectively.

13. A coated metal surface according to any one of the preceding claims, in which the polyamide is PA-12.

14. A coated metal surface according to any one of the preceding claims, which is the outer surface of a tube.

15. A coated metal surface according to claim 1, wherein said coated surface comprises, in succession starting from the metal:
a primer layer;
a tie layer; and
a polyamide-based layer comprising a blend of a polyamide and of a polyolefin functionalized by an unsaturated carboxylic acid anhydride.

16. A coated metal surface according to claim 15, wherein said primer layer is a layer of epoxy primer.

17. A coated metal surface according to claim 15 or 16, in which the tie layer comprises a functionalized polyolefin carrying a carboxylic acid or carboxylic acid anhydride functional group blended with an unfunctionalized polyolefin,
wherein the unfunctionalized polyolefin is selected from:
polyethylene homopolymers and copolymers;
propylene homopolymers or copolymers;
ethylene/alpha-olefin copolymers;
styrene/ethylene-butene/styrene, styrene/butadiene/styrene, styrene/isoprene/styrene and styrene/ethylene-propylene/styrene (SEPS) block copolymers;
copolymers of ethylene with at least one product chosen from salts or esters of unsaturated carboxylic acids or vinyl esters of saturated carboxylic acids, such as vinyl acetate, wherein the proportion of comonomer is up to 40% by weight; and
wherein the functionalized polyolefin (B1) is selected from:
alpha-olefin polymers having reactive groups;
a (co)polymers grafted with maleic anhydride, in which the (co)polymer is
PE, PP, copolymers of ethylene with propylene, butene, hexene or octene,
ethylene/alpha-olefin copolymers, ethylene/propylene rubber and ethylene/propylene diene;
styrene/ethylene-butene/styrene, styrene/butadiene/styrene, styrene/isoprene/styrene and styrene/ethylene-propylene/styrene block copolymers;
ethylene-vinyl acetate copolymers containing up to 40% vinyl acetate by weight;
ethylene-alkyl (meth)acrylate copolymers containing up to 40% alkyl (meth)acrylate by weight; and
ethylene-vinyl acetate (EVA)/alkyl (meth)acrylate copolymers containing up to 40% by weight of comonomers; and
a polymer of at least the following monomers: (1) ethylene; (2) an alkyl (meth)acrylate or a vinyl ester of a saturated carboxylic acid and (3) an anhydride.

18. A coated metal surface according to any one of claims 15 to 17, wherein the polyamide is selected from PA-11, PA-12, aliphatic polyamides resulting from the condensation of an aliphatic diamine having from 6 to 12 carbon atoms and of an aliphatic diacide having from 9 to 12 carbon atoms, and nylon-11/nylon-12 copolyamides having either more than 90% of nylon-11 units or more than 90% of nylon-12 units.

19. A coated metal surface according to claim 17, wherein
the polyamide is selected from PA-11, PA-12, aliphatic polyamides resulting from the condensation of an aliphatic diamine having from 6 to 12 carbon atoms and of an aliphatic diacid having from 9 to 12 carbon atoms, and nylon-11/nylon-12 co-polyamides having either more than 90% of nylon-11 units or more than 90% of nylon-12 units, and the proportion of functionalized polyolefin is from 1 to 20% by weight per 99 to 80% of polyamide; and
said primer layer is a layer of epoxy primer.

20. A coated metal surface according to one of the preceding claims, wherein the thickness of the polyamide layer is 120-180 μm, the thickness of the tie layer is 20-50 μm and the thickness of the primer layer is 10-15 μm.

21. A coated metal surface according to one of the preceding claims, wherein said coated metal surface comprises a tie layer and said tie layer is:
(a) a blend comprising 60 to 95 parts of a high-density polyethylene (C1) having a density of 0.940-0.965 and a melt flow index of 0.1 and 3 g/10 min (190° C./2.16 kg) and 40 to 5 parts of a polymer (C2) chosen from ethylene/propylene elastomers, ethylene/propylene/diene, very low-density polyethylene (VLDPE) which is either an ethylene homopolymer or an ethylene/alpha-olefin copolymer, or a copolymer of ethylene with at least one product chosen from (i) unsaturated carboxylic acids, their salts, their esters, (ii) vinyl esters of saturated carboxylic acids, and (iii) unsaturated dicarboxylic acids, their salts, their esters, their half-esters and their anhydrides, wherein the blend of (C1) and (C2) are cografted with an unsaturated carboxylic acid having from 2 to 20 carbon atoms;
(b) a blend comprising 5 to 30 parts of a polymer (D) and 95 to 70 parts of a polyethylene (E), polymer (D) being a blend of a polyethylene (D1) having a density of 0.910-0.940 and a polymer (D2) chosen from elastomers, very low-density polyethylenes and metallocene polyethylenes wherein the blend (D1)+(D2) is cografted by an unsaturated carboxylic acid, polyethylene (E) having a density of between 0.910 and 0.930,
wherein the blend of (D) and (E) has a density is of 0.910-0.930, a content of grafted unsaturated carboxylic acid of 30 and 10 000 ppm, a melt flow index (190° C./2.16 kg) of 0.1-3 g/10 min;
(c) a blend comprising 5 to 30 parts of a polymer (F) and 95 to 70 parts of a polyethylene (G), polymer (F) being a blend of a polyethylene (F1) having a density of 0.935-0.980 and a polymer (F2) chosen from elastomers, very low-density polyethylenes and ethylene copolymers wherein the blend (F1)+(F2) is cografted by an unsaturated carboxylic acid, polyethylene (G) having a density of 0.930-0.950,
wherein the blend of (F) and (G) has a density of 0.930-0.950, a content of grafted unsaturated carboxylic acid of 30-10 000 ppm, and a melt flow index of 5-100 g/10 min (190° C./21.6 kg);
(d) a polyethylene grafted by maleic anhydride, having a melt flow index of 0.1 to 3, a density of 0.920-0.930 and containing 2 to 40% by weight of materials insoluble in n-decane at 90° C., wherein the grafted polyethylene is diluted in an ungrafted polyethylene;
(e) a blend comprising 50 to 100 parts of a polyethylene homopolymer or copolymer (J), having a density of greater than or equal to 0.9, and 0 to 50 parts of a polymer (K) chosen from a polypropylene homopolymer or copolymer (K1), a poly(1-butene) homopolymer or copolymer (K2) and a polystyrene homopolymer or copolymer (K3), wherein the amount of (J)+(K) is 100 parts, the blend of (J)+(K) is grafted by at least 0.5% by weight of a functional monomer, and the grafted blend is diluted in at least one polyethylene homopolymer or copolymer (L) or in at least one polymer (M) having an elastomeric character or in a blend of (L) and (M);
(f) a blend comprising an HDPE-, LLDPE-, VLDPE- or LDPE-type polyethylene, 5 to 35% of a grafted metallocene polyethylene and 0 to 35% of an elastomer, the total being 100%;
(g) a blend comprising at least one polyethylene or one ethylene copolymer, at least one polymer chosen from polypropylene or a propylene copolymer, a poly(1-butene) homopolymer or copolymer, a polystyrene homopolymer or copolymer, and polypropylene, the blend being grafted by a functional monomer and optionally diluted in at least one polyolefin or at least one polymer having an elastomeric character or in a blend thereof;
(h) a blend comprising at least one LLDPE or VLDPE polyethylene, and at least one ethylene-based elastomer chosen from ethylene-propylene copolymers and ethylene-butene copolymers, the polyethylene-elastomer blend being grafted by an unsaturated carboxylic acid or a functional derivative thereof, the cografted blend optionally being diluted in a polymer chosen from polyethylene homopolymers or copolymers and styrene block copolymers, wherein the tie has (i) an ethylene content which is not less than 70 mol %, (ii) a carboxylic acid or carboxylic acid derivative content of 0.01 to 10% by weight of the tie, and (iii) an MFI₁₀/MFI₂ ratio of 5 to 20, where MFI₂ is the melt flow index at 190° C. under a load of 2.16 kg, and MFI₁₀ is the melt flow index at 190° C. under a load of 10 kg; or
(i) a blend comprising 5 to 35 parts of a polymer (S) and 95 to 65 parts of a polyethylene (T), polymer (S) being a blend comprising 80 to 20 parts of a metallocene polyethylene (S1), having a density of 0.865-0.915, and 20 to 80 parts of a non-metallocene LLDPE polyethylene (S2), and polyethylene (T) being chosen from polyethylene homopolymers or copolymers, and elastomers, the blend (S1)+(S2) being cografted by an unsaturated carboxylic acid, wherein the blend of (S) and (T) has a content of grafted unsaturated carboxylic acid of 30-100 000 ppm, and a melt flow index (190° C./2.16 kg) of 0.1-10 g/10 min.
